(19) United States
(12) Patent Application Publication
(10) Pub. No.: US 2006/0005588 A1
(43) Pub. Date: Jan. 12, 2006

(54) Steering lock

(76) Inventor: Masanari Okuno, Aichi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/168,042

(22) Filed: Jun. 28, 2005

(30) Foreign Application Priority Data
Jul. 8, 2004 (JP) 2004-202056

(51) Int. Cl. B60R 25/02

(52) U.S. Cl. 70/186

(57) ABSTRACT

A steering lock that reduces the force required to disengage a lock bar from a steering shaft without affecting the antitheft effect of the steering lock. The steering lock includes a lock bar engaged with the steering shaft at a lock position and disengaged from the steering shaft at an unlock position. A lock stopper is connected to the lock bar so as to enable movement of the lock bar between the lock position and the unlock position.

### BACKGROUND OF THE INVENTION

The present invention relates to a steering lock for engaging a lock bar with a steering shaft to disable steering.

Japanese Laid-Open Patent Publication No. 2000-225922 describes an example of a widely used mechanical steering lock for preventing automobile theft. In such a steering lock, a mechanical key is inserted in a key cylinder and turned to disengage a lock bar, which is engaged with a steering shaft, from the steering shaft. This enables the steering wheel to be turned, or the automobile to be steered. When the mechanical key is removed from the key cylinder, the lock bar is engaged with the steering shaft to disable steering. Accordingly, the turning of the steering wheel is restricted and the steering lock functions to prevent theft.

Japanese Laid-Open Patent Publication No. 2003-063354 describes an example of an electronic steering lock, which has been proposed in recent years to take place of mechanical steering locks. In such a steering lock, an actuator, such as a motor, drives a lock bar so that it engages a steering shaft to disable steering.

FIG. 4 shows a typical electronic steering lock 100. The steering lock 100 includes a motor 110 that drives a lock bar 130 to engage the lock bar 130 with a steering shaft 120 and disable steering.

In an automobile incorporating the steering lock 100, for example, when starting the engine, the steering lock 100 is in a lock state and steering is disabled. Thus, a steering lock ECU 140 controls the motor 110 to generate rotation (e.g., forward rotation) that disengages the lock bar 130 from the steering shaft 120. As a result, the steering lock 100 enters an unlock state and steering is enabled. Movement of the lock bar 130 from a lock position, where the lock bar 130 is engaged with the steering shaft 120, to an unlock position, where the lock bar 130 is disengaged from the steering shaft 120, activates an unlock detection switch 141.

The steering lock ECU 140 recognizes the unlock state of the steering lock 100 through the activation of the unlock detection switch 141. Upon recognition of the unlock state, the steering lock ECU 140 stops the motor 110. When the steering lock 100 is in the unlock state, one of the conditions for starting the engine is satisfied.

For example, if a door of the automobile is opened after the engine is stopped and the steering lock ECU 140 is in the unlock state, the steering lock ECU 140 controls the motor 110 to generate rotation (e.g., reverse rotation). This engages the lock bar 130 with the steering shaft 120. As a result, the steering lock 100 enters the lock state and disables steering. Movement of the lock bar 130 from the unlock position to the lock position activates a lock detection switch 142.

The steering lock ECU 140 recognizes the lock state of the steering lock 100 through the activation of the lock detection switch 142. Upon recognition of the lock state, the steering lock ECU 140 stops the motor 110. In the lock state, the steering lock 100 disables steering and functions to prevent theft.

Regardless of whether the steering lock is mechanical or electronic, when the lock bar is tightly engaged with the steering shaft, the force required to disengage the lock bar from the steering shaft (necessary disengagement force) becomes large. In a mechanical steering lock, the necessary large disengagement force may hinder the disengagement of the lock bar from the steering shaft when turning the mechanical key. In such a case, when turning the mechanical key, the steering wheel must be slightly turned to decrease the engaging force of the lock bar relative to the steering shaft. In an electronic steering lock, the large necessary disengagement force results in the need for a motor that generates a strong drive force. This leads to the employment of a large motor.

To reduce the necessary disengagement force, the portion of the lock bar engaged with the steering shaft may be tapered. This would ensure the disengagement of the lock bar from the steering shaft just by turning the mechanical key or just with the force of the motor. However, this may enable forcible unlocking of the steering lock. Accordingly, the tapering of the lock bar to reduce the necessary disengagement force may affect the antitheft effect of the steering lock.

### SUMMARY OF THE INVENTION

It is an object of the present invention to provide a steering lock that reduces the force required to disengage a lock bar from a steering shaft without affecting the antitheft effect of the steering lock.

One aspect of the present invention is a steering lock for locking a steering shaft connected to a steering wheel. The steering lock includes a lock bar that engages with the steering shaft at a lock position and disengages from the steering shaft at an unlock position. A lock stopper is movably connected to the lock bar so as to enable movement of the lock bar between the lock position and the unlock position.

Another aspect of the present invention is a steering lock for locking a steering shaft connected to a steering wheel. The steering lock includes a lock bar that engages with the steering shaft at a lock position and disengages from the steering shaft at an unlock position. The lock bar includes a slot and is movable in a first direction between the lock position and the unlock position. A lock stopper is movably connected to the lock bar so as to enable movement of the lock bar between the lock position and the unlock position. The lock stopper is partially received in the slot and is movable in a second direction that differs from the first direction. The lock stopper includes a first restriction portion engaged with the lock bar in the slot to restrict movement of the lock bar from the lock position to the unlock position when the lock bar is engaged with the steering shaft. A second restriction portion is engaged with the lock bar in the slot to restrict movement of the lock bar from the unlock position to the lock position when the lock bar is disengaged from the steering shaft.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing the structure of a steering lock according to a preferred embodiment of the present invention;

FIGS. 2A and 2B are schematic diagrams showing the operation of the steering lock;

FIGS. 3A and 3B are schematic diagrams showing the operation of the steering lock; and

FIG. 4 is a schematic diagram showing an example of a steering lock in the prior art.

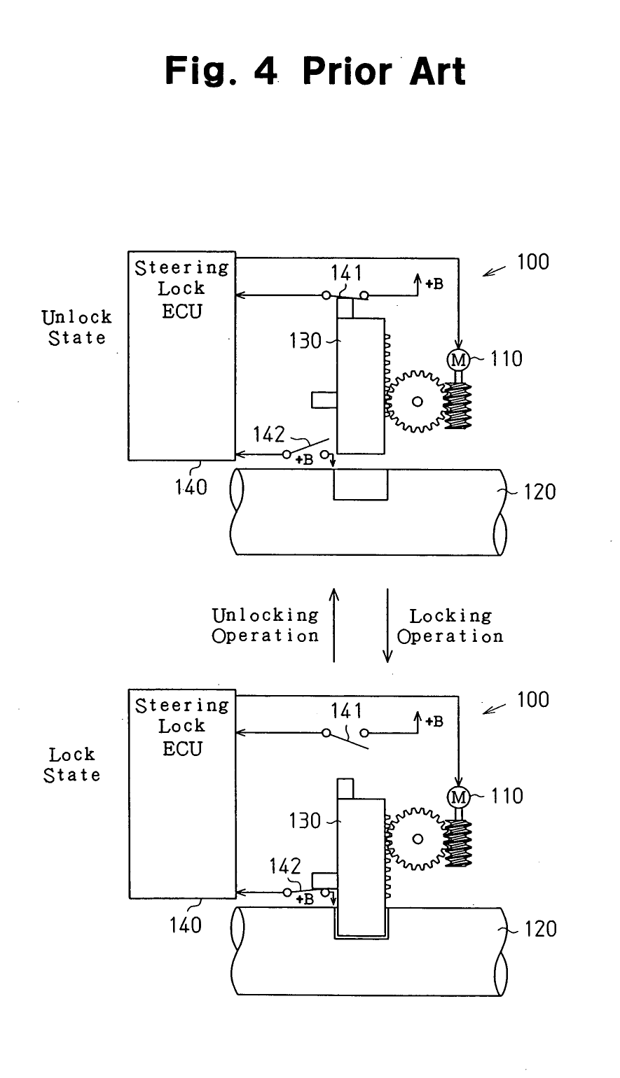

### DETAILED DESCRIPTION OF THE PREFERRED EMBODIMENTS

A steering lock 1, for use in an automobile, according to a preferred embodiment of the present invention will now be discussed.

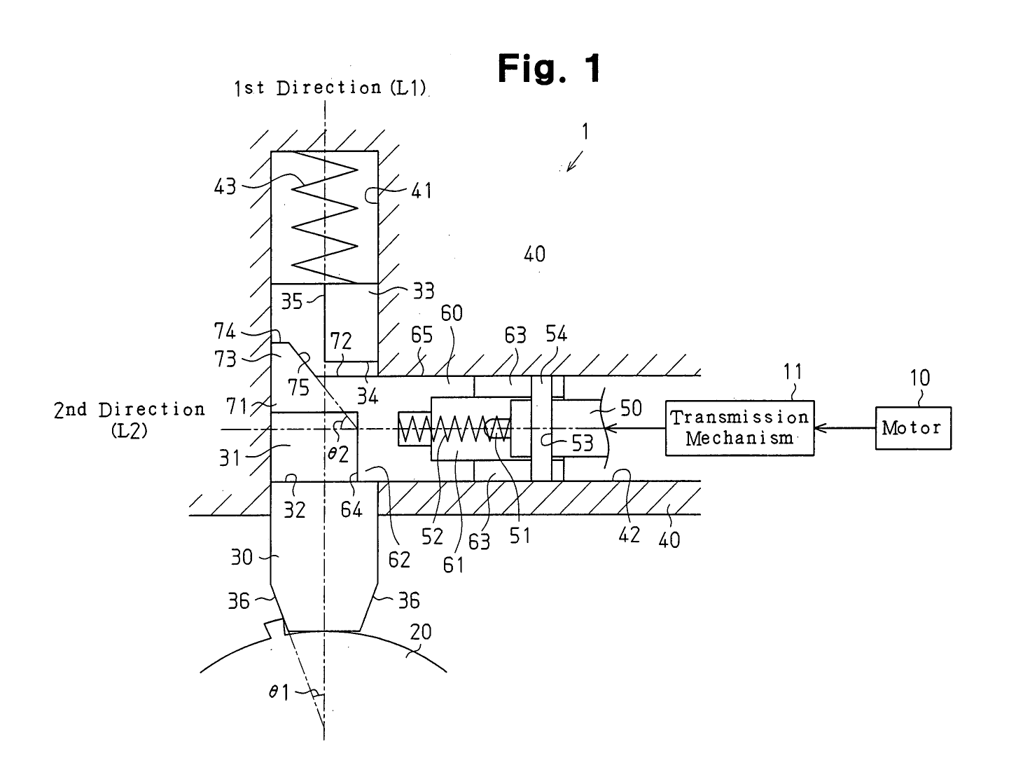

Referring to FIG. 1, the steering lock 1 is an electronic steering lock that uses the force generated by a motor 10 to engage a lock bar 30 with a steering shaft 20 and disable steering.

The motor 10 functions as a drive source for engaging the lock bar 30 with the steering shaft 20 and disengaging the lock bar 30 from the steering shaft 20. The motor 10 is a DC motor that generates rotation in the forward direction and reverse direction. The motor 10 is connected to a transmission mechanism 11, which transmits the rotation force of the motor 10 to a support 50. The transmission mechanism 11 includes a reduction gear train for reducing the speed of the rotation transmitted from a drive shaft (output shaft of the motor 10) to a driven shaft and a gear train for converting the rotary motion of the driven shaft to linear motion of the support 50.

The steering lock 1 includes a lock body 40. The lock body 40 includes a first socket 41, which movably receives the lock bar 30. The first socket 41 is linear and extends in a first direction in which the lock bar 30 is engaged with and disengaged from the steering shaft 20. The first socket 41 has an open end. The lock bar 30 received in the first socket 41 has a distal portion exposed from the lock body 40. The distal position is directly engaged with and disengaged from the steering shaft 20.

The lock body 40 also includes a second socket 42, which movably receives a lock stopper 60. The second socket 42 is linear and extends in a second direction, which differs from the first direction. In the preferred embodiment, the second socket 42 extends linearly along the second direction, which is perpendicular to the first direction. The lock stopper 60 received in the second socket 42 has a distal portion connected to the lock bar 30.

A coil spring, or spring 43, is accommodated in the first socket 41. The spring 43 is located between the wall defining the first socket 41 in the lock body 40 and the basal portion of the lock bar 30. The spring 43 urges the lock bar 30 towards the steering shaft 20.

The lock bar 30 includes a slot 31 for receiving the distal portion of the lock stopper 60. The slot 31 is defined by an inner lower surface 32 of the lock bar 30 and the wall surfaces of an engagement block 33 (engagement surface 34 and side surface 35), as viewed in FIG. 1. Tapered surfaces 36 are provided on opposite sides of the distal portion of the lock bar 30. The tapered surfaces 36 are each formed so that the distance from the axis L1 of the lock bar 30 decreases in a linear manner as the distal end of the lock bar 30 becomes closer. The angle θ1 between the axis L1 and each tapered surface 36 is set to 45 degrees or less. In the preferred embodiment, the angle θ1 is set to 20 degrees. The axis L1 of the lock bar 30 extends parallel to the first direction.

The support 50 is arranged in the second socket 42 to support the lock stopper 60. A spring seat 51 projects toward the lock bar 30 from the distal end of the support 50. The spring seat 51 stably supports a spring 52 arranged between the support 50 and the lock stopper 60. The spring 52 urges the lock stopper 60 toward the lock bar 30. A pin insertion hole 53 extends through the support 50 in a direction perpendicular to the second direction. A pin 54 is inserted through the pin insertion hole 53. The two ends of the pin 54 are engaged with the lock stopper 60.

The lock stopper 60 includes a receptacle 61 for receiving the spring 52 and the support 50. Two opposing elongated holes 63 extend through the walls of the lock stopper 60 and into the receptacle 61 along the second direction L2. The two ends of the pin 54 are movably received in the elongated holes 63.

A first restriction portion 62 is defined on the distal lower part of the lock stopper 60, as viewed in FIG. 1. An abutment surface 64 extends along an end face of the distal part of the lock stopper 60. An engagement piece 71 extends from the abutment surface 64. The engagement piece 71 has a basal portion including a flush surface 72 facing away from the steering shaft 20. The flush surface 72 is flush with an upper surface 65 of the lock stopper 60. Further, the engagement piece 71 has a second restriction portion 73 defined by the upper part of the engagement piece 71 so as to face away from the steering shaft 20. The second restriction portion 73 has a restriction surface 74 extending in a direction parallel to the engagement surface 34 of the engagement block 33 in the lock bar 30. The second restriction portion 73 includes an inclined surface 75 that connects the restriction surface 74 and the flush surface 72. The inclined surface 75 is formed so that the distance from the axis L2 of the lock stopper 60 decreases in a linear manner toward the basal side of the lock stopper 60 from the distal side. The angle θ2 between the axis L2 and the inclined surface 75 is set to 45 degrees.

The operation of the steering lock 1 will now be discussed with reference to the drawings.

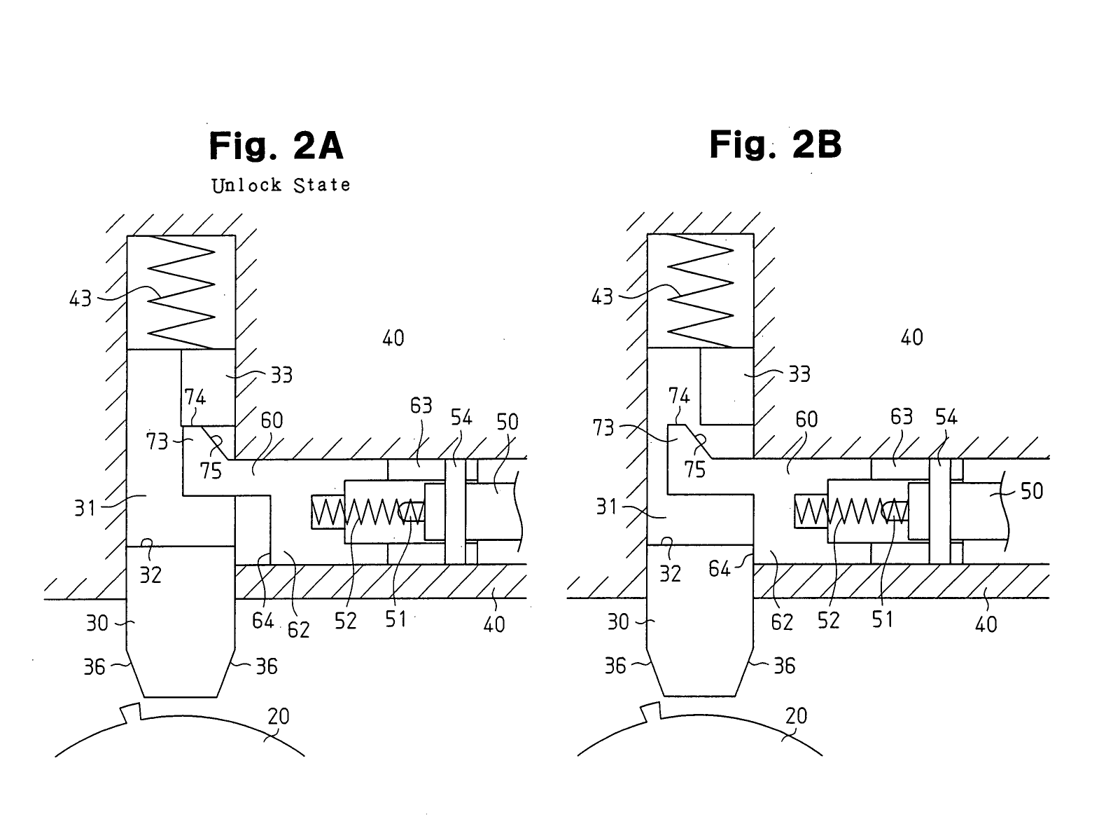

FIG. 2A shows the steering lock 1 in an unlock state in which the lock stopper 60 is held at a retracted position in the slot 31 of the lock bar 30. In this state, the engagement block 33 of the lock bar 30 is engaged with the restriction surface 74 of the second restriction portion 73 of the lock stopper 60. Further, the lock bar 30 is located at an unlock position. In the unlock state, the second restriction portion 73 functions to restrict movement of the lock bar 30 from the unlock position to a lock position.

In the unlock state, the motor 10 is driven to generate rotation for moving the support 50 toward the lock bar 30 by means of the transmission mechanism 11. This moves the lock stopper 60 forward, that is, further into the lock bar 30. The forward movement of the lock stopper 60 disengages the restriction surface 74 from the engagement block 33. Then, the abutment surface 64 of the lock stopper 60 abuts against the lock bar 30, as shown in the state of FIG. 2B.

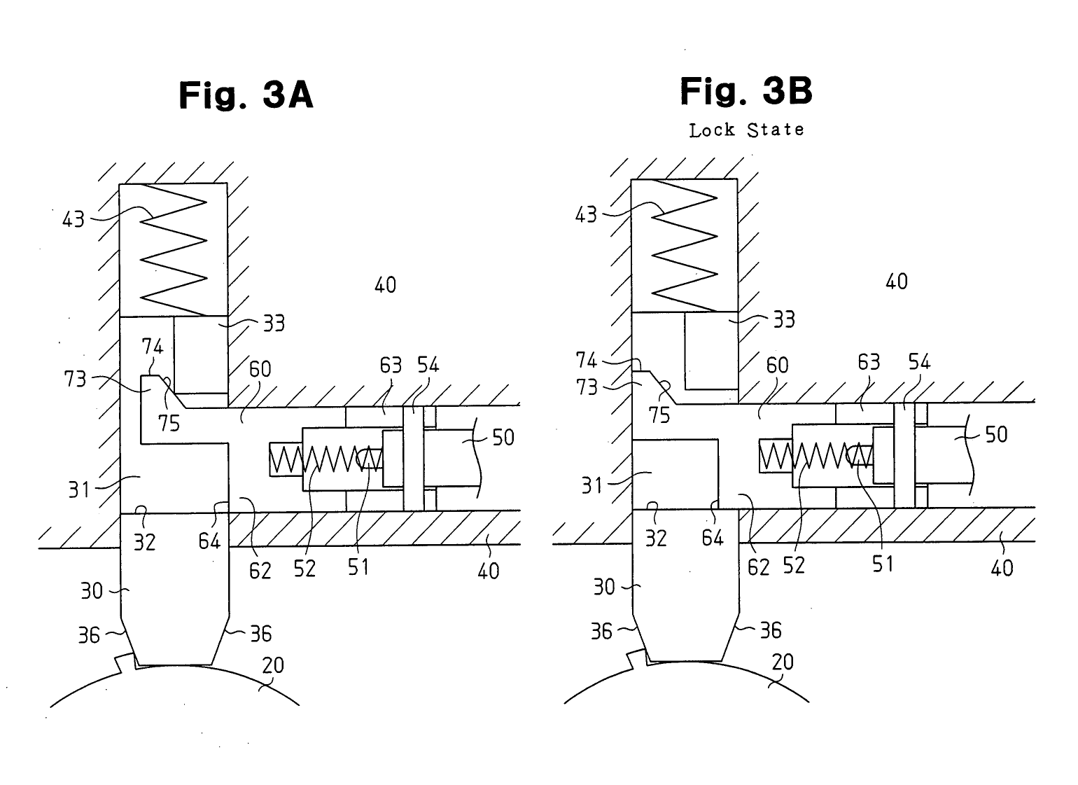

In this state, the spring 43 urges and moves the lock bar 30 toward the steering shaft 20. As a result, the engagement block 33 of the lock bar 30 comes into contact with the inclined surface 75, as shown in the state of FIG. 3A. In this state, the abutment surface 64 is disengaged from the lock bar 30.

Subsequently, the lock stopper 60 moves further forward into the lock bar 30 until the first restriction portion 62 engages the inner lower surface 32 of the lock bar 30. As a result, the steering lock 1 enters the lock state in which the lock bar 30 is located at the lock position, as shown in FIG. 3B. In this state, the first restriction portion 62 functions to restrict movement of the lock bar 30 from the lock position to the unlock position. The lock stopper 60 is held at a projected position in this state.

When disengaging the lock bar 30 from the steering shaft 20 in the lock state of FIG. 3B, the motor 10 is driven to generate rotation in the reverse direction. This moves the support 50 and the lock stopper 60 rearward, that is, away from the lock bar 30, by means of the transmission mechanism 11. As the lock stopper 60 moves rearward, the engagement block 33 of the lock bar 30 comes into contact with the inclined surface 75, as shown in the state of FIG. 3A. In this state, the first restriction portion 62 is disengaged from the inner lower surface 32.

Further rearward movement of the lock stopper 60 moves the engagement block 33 along the inclined surface 75 against the force of the spring 43 until the engagement block 33 becomes engaged with the restriction surface 74, as shown in the state of FIG. 2A. Accordingly, the lock stopper 60 moves the lock bar 30 from the lock position to the unlock position.

The preferred embodiment has the advantages described below.

(1) In addition to the engagement of the lock bar 30 with the steering shaft 20, the engagement of the lock stopper 60 with the lock bar 30 produces an antitheft effect. This allows the lock bar 30 to have the tapered surfaces 36 that adequately loosen the engagement between the lock bar 30 and the steering shaft 20. Thus, the force required to disengage the lock bar 30 from the steering shaft 20 is reduced. Accordingly, the steering lock 1 reduces the necessary disengagement force without affecting the antitheft effect.

(2) In the lock state, the first restriction portion 62 restricts movement of the lock bar 30 from the lock position to the unlock position. This maintains the steering lock 1 in the lock state.

(3) In the unlock state, the restriction surface 74 of the second restriction portion 73 restricts movement of the lock bar 30 from the unlock position to the lock position. This maintains the steering lock 1 in the unlock state.

(4) The tapered surfaces 36 of the lock bar 30 ensure the disengagement of the lock bar 30 from the steering shaft 20.

(5) The reduction of the necessary disengagement force shortens the time the motor 10 is activated. This improves responsiveness when starting the engine.

(6) The reduction of the necessary disengagement force enables the use of a smaller motor 10. Accordingly, the size of the steering lock 1 may be reduced.

(7) The reduction of the necessary disengagement force enables the reduction gear train of the transmission mechanism 11 to have a smaller reduction ratio. Accordingly, the size of the steering lock 1 may be reduced.

(8) The lock bar 30 and the lock stopper 60 of the steering lock 1 configure a double-axis structure. In comparison with when a steering lock includes only a lock bar so as to configure a single-axis structure, the motor 10 and the transmission mechanism 11 may be arranged closer to the steering shaft 20. This increases the antitheft effect of the steering lock 1.

It should be apparent to those skilled in the art that the present invention may be embodied in many other specific forms without departing from the spirit or scope of the invention. Particularly, it should be understood that the present invention may be embodied in the following forms.

The steering lock 1 may be configured in a manner that the second direction is not perpendicular to the first direction as long as the second direction differs from the first direction. It is only required that the steering lock 1 includes the lock bar 30 and the lock stopper 60 configuring a double-axis structure.

The angle θ1 does not have to be 20 degrees as long as it is 45 degrees or less. It is not preferable for the angle θ1 to be greater than 45 degrees since this may frequently cause tight engagement between the lock bar 30 and the steering shaft 20.

The angle θ2 does not have to be 45 degrees as long as it is less than 90 degrees.

Any urging means may be used in lieu of the springs 43 and 52.

A coating may by applied to the surfaces of the lock bar 30 and the steering shaft 20 to reduce the necessary disengagement force.

Any kind of actuator may be used in lieu of the motor 10.

The concavo-convex relationship of the steering shaft 20 and the lock bar 30 may be reversed.

The present invention may be applied to a mechanical steering lock. This would reduce the frequency in which the steering wheel would have to be slightly turned when turning a mechanical key to reduce the engagement force between the steering shaft and lock bar. As a result, convenience would be improved.

The present examples and embodiments are to be considered as illustrative and not restrictive, and the invention is not to be limited to the details given herein, but may be modified within the scope and equivalence of the appended claims.

What is claimed is:

1. A steering lock for locking a steering shaft connected to a steering wheel, the steering lock comprising:
a lock bar that engages with the steering shaft at a lock position and disengages from the steering shaft at an unlock position; and
a lock stopper movably connected to the lock bar so as to enable movement of the lock bar between the lock position and the unlock position.

2. The steering lock according to claim 1, wherein:
the lock bar engages with and disengages from the steering shaft in a first direction; and
the lock stopper is movable in a second direction that differs from the first direction.

3. The steering lock according to claim 2, wherein the lock stopper is movable in the second direction that is substantially perpendicular to the first direction in which the lock bar engages with and disengages from the steering shaft.

4. The steering lock according to claim 1, wherein the lock stopper includes a first restriction portion for restricting movement of the lock bar from the lock position to the unlock position when the lock bar is engaged with the steering shaft.

5. The steering lock according to claim 4, wherein the lock stopper includes a second restriction portion for restricting movement of the lock bar from the unlock position to the lock position when the lock bar is disengaged from the steering shaft.

6. The steering lock according to claim 1, wherein:
the lock bar includes a slot for partially receiving the lock stopper; and
the lock stopper includes:
a first restriction portion engaged with the lock bar in the slot to restrict movement of the lock bar from the lock position to the unlock position when the lock bar is engaged with the steering shaft; and
a second restriction portion engaged with the lock bar in the slot to restrict movement of the lock bar from the unlock position to the lock position when the lock bar is disengaged from the steering shaft.

7. The steering lock according to claim 6, further comprising:
an actuator for moving the lock stopper.

8. The steering lock according to claim 7, wherein the actuator moves the lock stopper and disengages the first restriction portion or the second restriction portion from the lock bar to enable movement of the lock bar between the unlock position and the lock position.

9. The steering lock according to claim 8, wherein the lock stopper includes an abutment surface that abuts against the lock bar outside the slot when the lock bar moves between the unlock position and the lock position.

10. The steering lock according to claim 9, further comprising:
an urging mechanism for urging the lock bar toward the steering shaft.

11. The steering lock according to claim 9, wherein the lock stopper includes an inclined surface located in the slot and continuously extending from the second restriction portion, and the urging mechanism forces the lock bar against the inclined surface to move the lock bar between the unlock position and the lock position when the actuator moves the lock stopper.

12. The steering lock according to claim 1, wherein the lock bar includes a tapered distal portion.

13. A steering lock for locking a steering shaft connected to a steering wheel, the steering lock comprising:
a lock bar that engages with the steering shaft at a lock position and disengages from the steering shaft at an unlock position, the lock bar including a slot and being movable in a first direction between the lock position and the unlock position; and
a lock stopper movably connected to the lock bar so as to enable movement of the lock bar between the lock position and the unlock position, the lock stopper being partially received in the slot and being movable in a second direction that differs from the first direction, the lock stopper including:
a first restriction portion engaged with the lock bar in the slot to restrict movement of the lock bar from the lock position to the unlock position when the lock bar is engaged with the steering shaft; and
a second restriction portion engaged with the lock bar in the slot to restrict movement of the lock bar from the unlock position to the lock position when the lock bar is disengaged from the steering shaft.

14. The steering lock according to claim 13, further comprising:
an actuator for moving the lock stopper.

15. The steering lock according to claim 14, wherein the actuator moves the lock stopper and disengages the first restriction portion or the second restriction portion from the lock bar to enable movement of the lock bar between the unlock position and the lock position.

16. The steering lock according to claim 15, wherein the lock stopper includes an abutment surface that abuts against the lock bar outside the slot when the lock bar moves between the unlock position and the lock position.

17. The steering lock according to claim 16, further comprising:
an urging means for urging the lock bar toward the steering shaft.

18. The steering lock according to claim 17, wherein the lock stopper includes an inclined surface located in the slot and continuously extending from the second restriction portion, and the urging means forces the lock bar against the inclined surface to move the lock bar between the unlock position and the lock position when the actuator moves the lock stopper.

19. The steering lock according to claim 13, wherein the lock bar includes a tapered distal portion.
